(19) United States
(12) Patent Application Publication
(10) Pub. No.: US 2008/0158015 A1
(43) Pub. Date: Jul. 3, 2008

(54) Identification Arrangement for a Vehicle

(76) Inventor: Stefan Hammes, Regensburg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/937,216

(22) Filed: Nov. 8, 2007

(30) Foreign Application Priority Data
Nov. 14, 2006 (DE) 10 2006 053 619.3

(51) Int. Cl. G08G 1/123

(52) U.S. Cl. 340/991

(57) ABSTRACT

An identification arrangement (IA1) for a vehicle (FZ1) has a vehicle-side transmitting/receiving device (SE1) for receiving an identification signal (IDS) containing an identification code (CO). The identification arrangement also has a control and evaluation device (ST1) for checking the identification code of the identification signal, as well as for outputting a control signal (LSS, ASS) for the purpose of activating a vehicle function device (BL1, HU1) such as a turn signal indicator device if the identification code was recognized as valid, or for prompting the transmitting/receiving device to retransmit the received identification signal if the identification code was recognized as invalid. In this way it is possible for an identification signal transmitted by an identification transmitter, if recognized as invalid by the identification arrangement of the vehicle, to be transmitted to one or more further vehicles in order to be checked there.

### CROSS-REFERENCE TO RELATED APPLICATIONS

This application claims priority to German Patent Application Number 10 2006 053 619.3 filed on Nov. 14, 2006, and which is incorporated herein by reference in its entirety.

### TECHNICAL FIELD

The present invention relates to an identification arrangement or access arrangement for a vehicle as well as to a method for identifying an identification signal.

### BACKGROUND

In modern-day vehicles or, more specifically, motor vehicles there is an increasing trend to provide more and more electronic access authorization systems in which an access authorization request is initiated by means of a remote control. In the simplest case said access authorization system consists of one or more electronically controllable locks, a control device and at least one associated electronic key, i.e. the remote control. If a user or, more specifically, driver, upon returning from shopping for example, wishes to gain access to his/her vehicle, he/she will press a button on his/her remote control, which thereupon transmits the access authorization request or, as the case may be, an identification signal. If the user's vehicle is located within suitable range to receive the identification signal, which is mostly transmitted as a radio signal, it will, upon completion of a positive verification of the identification signal, unlock the locks of the vehicle. More sophisticated access authorization systems not only have the remotely controllable function of opening or closing locks of a vehicle, but in addition also include what is referred to as a “car finder function”, which is to say a function for locating the vehicle for instance on a large parking lot with a multiplicity of parked vehicles. For that purpose the user's electronic key or remote control can transmit a special signal for locating the vehicle, or the locating function can be triggered when the vehicle receives the identification signal for unlocking the door locks.

Let us now refer back to the situation in which a user is returning from shopping, for example, and wishes to locate his/her own vehicle on a large parking lot with a multiplicity of parked vehicles. If the user now presses a corresponding button on his/her remote control in order to generate a signal that will prompt the vehicle to trigger a corresponding vehicle function or locating function, such as, for example, a periodic outputting of light signals or acoustic signals, the problem can occur that, due to the limited range of the transmitting device of the remote control, the radio signal of the remote control does not reach the associated vehicle (or does not reach it correctly or, more specifically, does not reach it with sufficient field strength) in order to initiate the locating function there. Consequently, finding one's own vehicle becomes a laborious and time-consuming process, since the user must cross the entire parking lot on foot in search of his/her vehicle.

### SUMMARY

A simple and reliable means for locating a vehicle can be provided according to an embodiment by an identification arrangement or a vehicle comprising such an identification arrangement, wherein the identification arrangement comprises a vehicle-side transmitting/receiving device for receiving an identification signal containing an identification code, and a control and evaluation device which is operable to check the identification code of the identification signal, to output a control signal for activating a vehicle function device if the identification code was recognized as valid, or to prompt the vehicle-side transmitting/receiving device so that the latter will retransmit the identification signal if the identification code was recognized as invalid.

According to a further embodiment, the vehicle function device may have output means for outputting signals which can be perceived by a user upon its activation. According to a further embodiment, the identification signal may include blocking information which prevents the retransmission of the identification signal by the vehicle-side transmitting/receiving device. According to a further embodiment, the identification signal may include count information which is incremented before a retransmission of the identification signal. According to a further embodiment, the vehicle-side transmitting/receiving device can be configured to not retransmit the identification signal if the count information exceeds a predefined limit value. According to a further embodiment, the identification arrangement may further include a mobile identification transmitter assigned to a user and configured to transmit an identification signal containing an identification code. According to a further embodiment, the mobile identification transmitter also may provide address information that is characteristic of it in the identification signal. According to a further embodiment, at least one section of the address information may be blocked, and by this means the blocking information may be implemented.

According to another embodiment, a method for identifying an identification signal, may comprise the steps of: Reception of an identification signal containing an identification code by a vehicle; Checking of the identification code of the identification signal; Execution of a vehicle function if the identification code was recognized as valid, or Retransmission of the identification signal if the identification code was recognized as invalid.

According to a further embodiment of the method, the vehicle function may include a transmitting of signals that can be perceived by a user. According to a further embodiment of the method, the identification signal may include blocking information which prevents the retransmission of the identification signal. According to a further embodiment of the method, the identification signal may include count information which is incremented before a retransmission of the identification signal. According to a further embodiment of the method, the identification signal does not retransmitted if the count information exceeds a predefined limit value. According to a further embodiment of the method, the identification signal received by the vehicle can be transmitted by a mobile identification transmitter.

### BRIEF DESCRIPTION OF THE DRAWINGS

Exemplary embodiments of the present invention will be explained in more detail below with reference to the accompanying drawings, in which:

FIG. 1 shows a schematic representation of an identification arrangement or, as the case may be, of a keyless electronic access authorization system in a vehicle according to an embodiment;

FIG. 2 is a flowchart intended to represent the operation of an identification arrangement according to an embodiment;

FIG. 3 shows a schematic representation to illustrate the locating of a vehicle by means of an identification signal which is forwarded by a plurality of vehicles to the vehicle assigned to an identification transmitter;

FIG. 4 shows a schematic representation of an identification signal according to an embodiment.

### DETAILED DESCRIPTION

According to various embodiments, an identification arrangement or access arrangement for a vehicle may comprise the following features. A (first) vehicle-side transmitting/receiving device (for a first vehicle) is provided for receiving an identification signal containing an identification code. The identification arrangement further includes a (first) control and evaluation device for the (first) vehicle for the purpose of verifying the identification code of the identification signal. In particular the validity of the identification code is checked in this process, namely whether the code belongs to a transmitter associated with the vehicle or to an identification transmitter assigned to the user. The control and evaluation device is also configured on the one hand for outputting a control signal for activating a vehicle function device if the identification code is recognized as valid or on the other hand for outputting a forwarding signal to the (first) vehicle-side transmitting/receiving device in order that the latter will retransmit the identification signal if the identification code was recognized as invalid. Owing to this principle of operation whereby a received identification signal which does not contain a valid code is retransmitted so that the identification signal can be received for example by a further identification arrangement of a further or, as the case may be, second vehicle for which the identification signal was intended (or for which the identification code is valid), the identification signal can be transmitted over a long distance or over a large area in order to find the vehicle that was intended to receive said signal.

According to an embodiment of the identification arrangement, the vehicle function device can have output means for outputting signals that can be perceived by a user upon activation of the vehicle function device. The vehicle function device can therefore serve in this arrangement as a signaling device for a user. To that end the output means can comprise a turn signal indicator or some other lighting device of the vehicle in order to output optical signals or light signals in the form of a single flash or multiple flashes of light. It is, however, also conceivable that alternatively or in addition thereto the output means includes a noise or tone generator, such as a horn, in order to output acoustic signals.

According to a further embodiment it is possible for the identification signal to include blocking information which prevents or, as the case may be, forbids the retransmission of the identification signal by the (first) vehicle-side transmitting/receiving device. In this case it is possible to prevent a vehicle that is a long distance away from a user from outputting signals (optically or acoustically), and thereby also drawing the attention of other persons to the vehicle. Above all when reception of a valid identification code containing an identification signal is accompanied by an unlocking of the door locks of the vehicle, it can be advantageous if this only happens in the case of a vehicle which is located in proximity to the user.

In order to transmit the identification signal, the identification arrangement can comprise a mobile identification transmitter which is assigned to a user and configured for the purpose of transmitting the identification signal containing the identification code. In practical terms the identification transmitter comprises an actuation device such as a button which can be pressed by a user, whereupon finally the identification signal is generated and can be transmitted via a corresponding transmitting/receiving device on the identification transmitter side. Said identification transmitter, which thus serves as a remote control, can be implemented for example as an electronic key which, as already mentioned, can additionally have the function of obtaining access to a vehicle by transmission of an access request. In this case the identification signal can also serve as an access request.

It is possible with this arrangement that the identification transmitter provides address information that is characteristic of it in the identification signal. Said information can use the (first) control and evaluation device in order to identify the exact origin of the identification signal and possibly control the vehicle function device in a specific manner. For example, it is possible that when specific address information is detected in the identification signal, only an optical output means of the vehicle function device will be activated, whereas when different address information is detected an optical and acoustic output means can be activated. It should be mentioned that it is also possible that not just address information can be used for the purpose of the (just described) activation of the vehicle function device or, as the case may be, optical and/or acoustic output means, but that the identification transmitter provides control information specifically for this purpose in the identification signal.

Furthermore it is also possible for the address information to consist of a plurality of sections or, as the case may be, address sections, at least one address section being blocked for detecting or, as the case may be, reading. If, for example, the (first) control and evaluation device detects that an address section is blocked, it can interpret this as the presence of blocking information, and upon evaluation of a received identification code as invalid or omit to prompt the (first) vehicle-side transmitting/receiving device to retransmit the identification signal.

As has been explained above, the control and evaluation device is configured to output a forwarding signal to the vehicle-side transmitting/receiving device so that the latter will retransmit the identification signal if the identification code was recognized as invalid. In this case it is also possible for the vehicle-side transmitting/receiving device to insert count information or “hopping” information into the identification signal upon retransmission in order to ensure that the “target vehicle” is not reached after an arbitrary number of forwarding operations (or circular arguments). It is possible here that the “hopping” information includes a counter or count value which is incremented (by 1, for example) if the identification code is recognized as invalid. The count value thus indicates how often or by how many vehicles the identification signal has already been forwarded. As a condition for a (re)transmission it could then be specified that the received “identification code invalid” and the count value or the number of transmissions (hops) is less than or less than or equal to a predefined limit value. The count value could also be used to differentiate (in the event that the identification code is recognized as valid) between the output of optical and acoustic signals, e.g. few hops: optical signaling; many hops: optical and acoustic signaling.

According to a further embodiment, a vehicle, in particular a motor vehicle, is provided which has an identification arrangement as presented above.

According to a further embodiment, a method for identifying an identification signal is provided which has the following steps. First, an identification signal containing an identification code is received from a vehicle. Next, the identification code of the identification signal is checked. Now, either a vehicle function is executed if the identification code was recognized as a valid identification code, or the identification signal is retransmitted by the vehicle if the identification code was recognized as invalid. In this way it is possible for vehicles to pass on a received identification signal when they receive it but realize that it is not intended for them. Thus, an identification signal can be sent over a large area or a long distance without the necessity to increase the range and consequently the field strength of an individual transmitter of an identification signal.

Advantageously, the identification signal may be transmitted by a user's mobile identification transmitter. Because the identification signal is relayed, as already described above, it is also not necessary to increase the transmit power of the identification transmitter's transmitting device in order to be able to cover a large area or bridge a long distance for the purpose of controlling the vehicle assigned to the identification transmitter by means of the identification signal.

According to a possible embodiment, the vehicle function can include an outputting of optical signals (flashes of light, for example) and/or an outputting of acoustic signals (hooting sounds, for example).

Advantageous embodiments of the above-described identification arrangement can to that extent also be transferred to the vehicle or the method, and are also to be regarded as advantageous embodiments of the vehicle or the method.

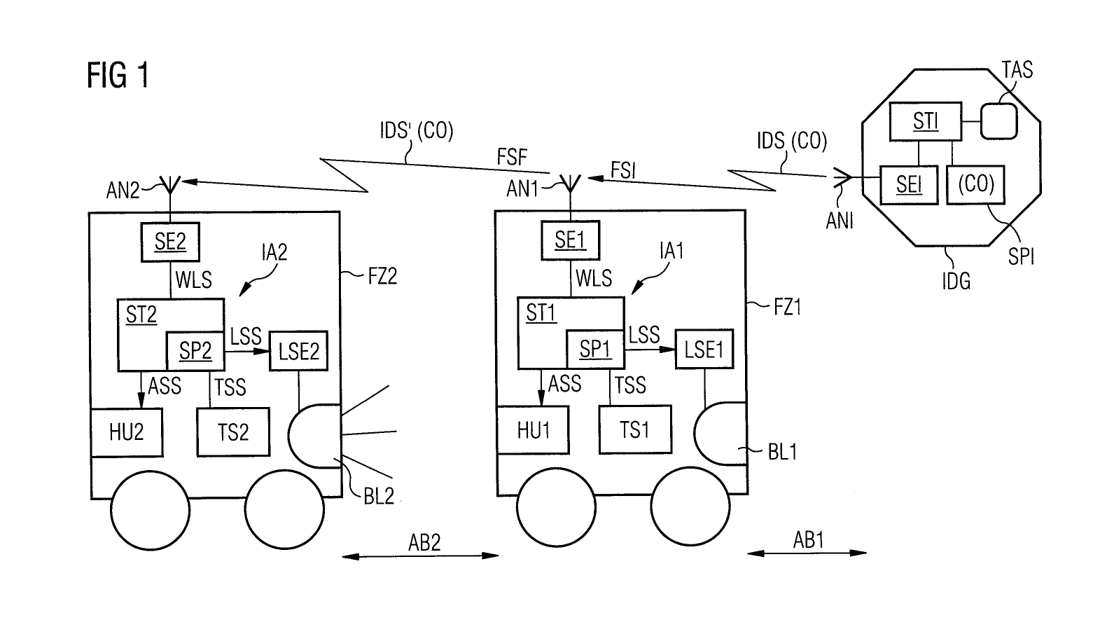

Referring first to FIG. 1, two vehicles, in this case motor vehicles FZ1 and FZ2, are shown. In the example illustrated here, the two vehicles FZ1 and FZ2 are of identical design or comprise the same devices with the same functions. The reference labels of the devices of the vehicle FZ1 end with the digit “1”, while reference labels of the corresponding devices of the vehicle FZ2 end with the digit “2”. Owing to the identity of design, the vehicle FZ1 will first be described in more detail below, the statements made with reference thereto also applying analogously to the vehicle FZ2.

The vehicle FZ1 comprises an identification arrangement IA1, which in this case is part of an access arrangement or of an access authorization system. The access arrangement IA1 has therein a vehicle-side control and evaluation device (referred to in the following as control device for short) ST1, which is connected to various further devices. In this arrangement the control device ST1 is connected to a vehicle-side transmitting/receiving device SE1 which is able to communicate by means of a vehicle-side antenna AN1 via a radio link firstly with a mobile identification transmitter IDG (via the radio link FSI) and secondly with one or more further vehicles (via the radio link FSF). The control device ST1 is also connected to a light control device LSE1, said light control device LSE1 being able, upon receiving a light control signal LSS, to activate or deactivate a lighting device BL1, in this case taking the form of a turn signal indicator or lower-beam headlamp, for example. The control device ST1 is additionally connected to a vehicle horn HU1, said vehicle horn HU1 being able, upon receiving an acoustic control signal ASS, to output an acoustic signal or horn signal. In this case the light control device LSE1 or the lighting device BL1 provides optical output means for outputting optical signals to a driver or user, while the horn HU1 provides an acoustic output means for outputting acoustic signals for a user or driver.

In the example described here, the identification arrangement IA1 is, as already mentioned, part of an access arrangement which unlocks one or more door locks of the vehicle FZ1 for a user, for example in response to a corresponding access request which is transmitted by the mobile identification transmitter IDG. For this purpose the control device ST1 is also connected to a door lock TS1, said door lock TS1, which can represent a central locking system for example, being controllable from the control device ST1 by means of a door signal TSS, either for unlocking (or also locking) the door lock TS1.

As has been described in the foregoing, the vehicle FZ1 will communicate with the mobile identification transmitter IDG via the radio link FSI or receive an identification signal IDS containing a code CO from said mobile identification transmitter IDG. A prerequisite for this is that the mobile identification transmitter IDG is located within a certain area around the vehicle at a distance that is less than the distance AB1, in which the signals emitted by the mobile identification transmitter IDG still have a sufficient field strength to be received correctly by the vehicle FZ1. For the purpose of emitting or transmitting signals a mobile identification transmitter IDG has an identification-transmitter-side antenna ANI which is connected to an identification-transmitter-side transmitting device or to a transmitting/receiving device SEI (as shown in FIG. 1). Connected to the identification-transmitter-side transmitting/receiving device is an identification-transmitter-side control device STI which is connected to a button TAS for actuation by a user as well as to a memory SPI for storing the code or identification code CO. When a user presses the button TAS, this actuation is reported to the control device STI, whereupon the latter fetches the code CO from the memory SPI (or computes it from data stored in the memory) and causes the transmitting/receiving device SEI to transmit an identification signal IDS containing the identification code CO via the antenna ANI.

It should also be mentioned that in order to use the identification transmitter IDG in the form of a remote control in which the identification transmitter only transmits signals, it is also necessary to provide only a transmitting device (instead of the transmitting/receiving device just described). If, however, the identification transmitter is (also) to be used as part of a passive access authorization system or a passive access arrangement in which the vehicle FZ1 initially sends a request signal to the identification transmitter IDG so that the latter will finally send back the identification signal containing the identification code for verification purposes, it is advantageous to equip the identification transmitter IDG with a transmitting/receiving device.

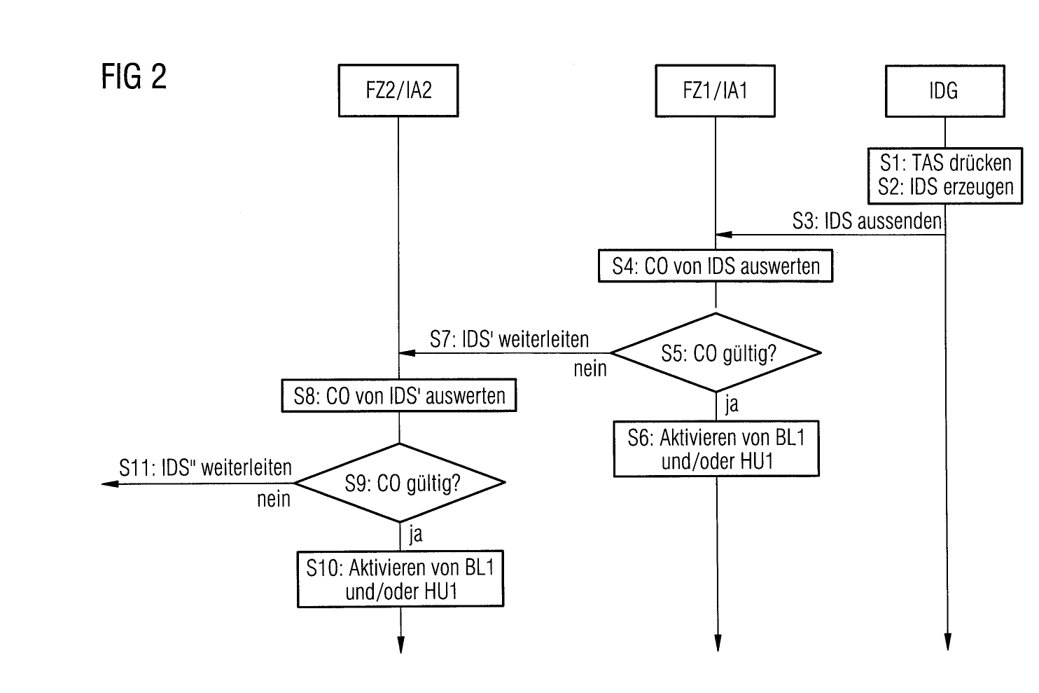

Reference is now made to FIG. 2, in which a flowchart is shown for the purpose of representing in detail the operation of an access arrangement IA1 or IA2 of the vehicles FZ1 and FZ2 (compare FIG. 1) according to one embodiment. In this case a situation is assumed in which the two vehicles FZ1 and FZ2 are parked for example on a large parking lot, and the user of the identification transmitter IDG would like to know where he/she parked his/her vehicle or, as the case may be, the vehicle assigned to the identification transmitter IDG. To that end, in step S1 the user of the identification transmitter IDG will press the button TAS of the identification transmitter, whereupon, as already mentioned above, the control device STI prompts the transmitting/receiving device SEI to generate the identification signal IDS containing the identification code CO according to step S2. Said identification signal IDS is then transmitted via radio link FSI according to step S3, the identification signal IDS finally being received by the vehicle FZ1 or, as the case may be, the antenna AN1. The received identification signal is then forwarded to the first control device ST1, where it is then evaluated according to step S4. More precisely, according to this embodiment the identification code CO of the identification signal IDS is evaluated. To that end, the control device ST1 compares a reference code stored in the memory device SP1 with the received identification code of the identification transmitter. If, in step S5, it is recognized by the control device ST1 that the reference code tallies with the received identification code CO, i.e. that the received identification code CO is valid, according to step S6 one or more output means are activated for the purpose of outputting signals which can be perceived by the user of the identification transmitter IDG. More precisely, upon a successful or positive verification of the identification code, the control device ST1 can output a light control signal LSS to the light control device LSE1 so that the latter will activate the lighting device BL1 and effect for example a single flash or repeated flashes of light. In addition or alternatively thereto, the control device ST1 can send a signal ASS to the horn HU1 so that the latter will be activated for the purpose of outputting acoustic signals. After receiving or perceiving the optical and/or acoustic signals, the user of the identification transmitter IDG knows where his/her vehicle (FZ1) is parked and can make his/her way to it.

In the event that the vehicle FZ1 which initially received the identification signal is not assigned to the identification transmitter IDG, it will become clear in step S5 that the identification code CO transferred with the identification signal IDS is invalid for the vehicle FZ1, with the result that in this case the control device ST1 prompts the transmitting/receiving device SE1 to generate a new identification signal IDS′ containing the identification code CO and transmit same by means of the antenna AN1 via radio link FSF according to step S7. Since the identification signal IDS′ corresponds to the identification signal IDS, it is possible in this case to talk of a forwarding of the identification signal IDS by the vehicle FZ1. It should be mentioned here that before the signal is forwarded, information (hopping information) relating to the number of forwarding operations can be inserted into the identification signal IDS′ or updated therein by the transmitting/receiving device SE1 (for example by prompting the control device ST1). In the example, said information in the situation just described would then have the value “1”, since this relates to the first forwarding operation.

As shown schematically in FIG. 1, the distance AB1 between the mobile identification transmitter IDG and the vehicle FZ1 is less than the distance AB2 between the vehicle FZ1 and the vehicle FZ2. In the following example this is intended to express that the transmit power of the transmitting/receiving device SEI of the identification transmitter IDG is less than the transmit power of the transmitting/receiving device SE1 of the vehicle FZ1. The vehicle FZ1 is thus able to transmit the identification signal IDS′ at such a (greater) transmit power that it can be correctly received by an object such as the second vehicle FZ2 at a greater distance from the vehicle FZ1.

The vehicle FZ2 is therefore located within an area around the vehicle FZ1 (as shown in FIG. 1) in which it is able to correctly receive the identification signal IDS′ containing the identification code CO. The identification signal received by the antenna AN2 is then routed by the transmitting/receiving device SE2 to the control device ST2, by which it is finally evaluated in respect of the identification code CO according to step S8. In the process the control device ST2 will compare the identification code CO received together with the identification signal IDS′ with a reference code stored in the memory SP2 in order to check the validity of the identification code CO or the assignment of the vehicle FZ2 to the identification transmitter IDG transmitting the identification code. If the control device ST2 confirms in step S9 that the received identification code is valid (and that therefore the vehicle FZ2 is assigned to the identification transmitter IDG), then in step S10 the control device ST2 will activate one or more output means for the purpose of outputting signals which can be perceived by a user. In this case the control device ST2 can emit a light control signal LSS to the light control device LSE2 so that the latter will activate the lighting device BL2 (effecting, for example, a single flash or multiple flashes of light). In addition or alternatively thereto, the control device ST2 can output a signal ASS to the horn HU2 so that the latter will output an acoustic signal in the form of a hooting sound. It should be remarked that this situation, wherein the second vehicle FZ2 is assigned to the identification transmitter IDG, is intended to be indicated in FIG. 1, since in this case a lighting device BL2 is shown in the activated state.

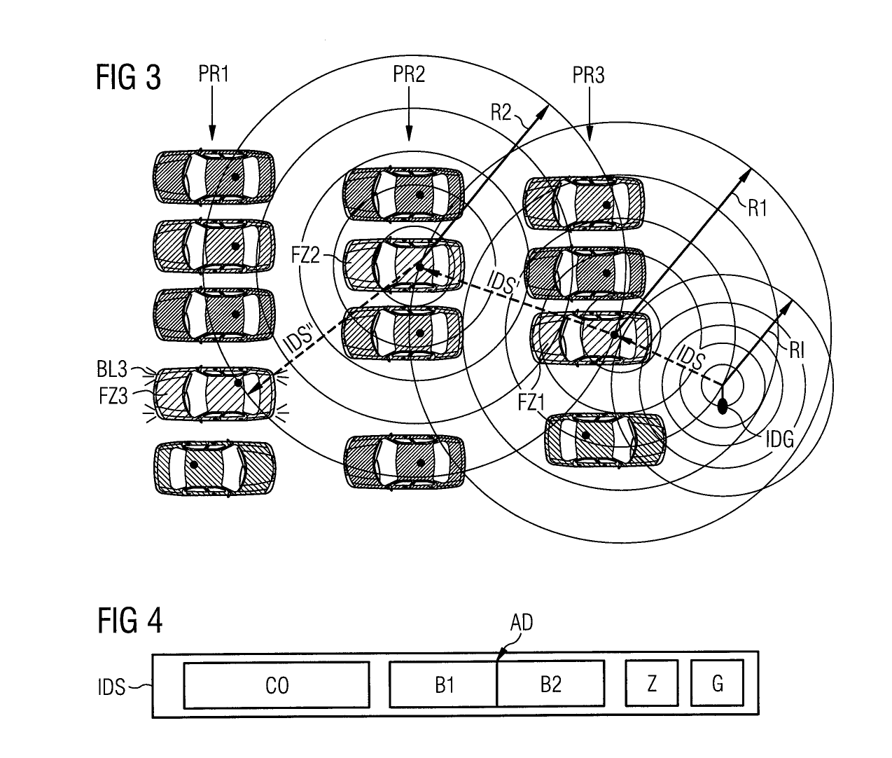

If, however, it should transpire in step S9 that the code CO is invalid, in step S11 the second vehicle FZ2 too will (prompted by the control device ST2) retransmit or forward the identification signal (in the form of the identification signal IDS″). Before the signal is forwarded, the hopping information can then be updated again and incremented or, in the situation just described, set from “1” to “2”. According to the above explanation, an identification signal forwarded in this way can then be received by one or more further vehicles and checked in respect of the validity of the identification code contained therein. It should be mentioned that the forwarding of the information signal can be made dependent on the number of forwarding operations in the hopping information not yet having exceeded a predefined limit value. When a signal is forwarded it must therefore be checked whether on the one hand a code CO has been recognized as invalid and on the other hand the predefined limit value for forwarding operations has not yet been exceeded. In other words, if the number of forwarding operations exceeds the limit value, the identification signal will not be forwarded even though the code CO has not been recognized as valid.

Whereas in FIGS. 1 and 2 only the situation was described in which the identification signal IDS of the identification transmitter IDG is forwarded only by one vehicle, reference will now be made to FIG. 3, in which a forwarding of the identification signal across a plurality of vehicles is shown in a schematic representation. Here, FIG. 3 shows a group of vehicles which are parked for example on a large parking lot in three rows PR1, PR2, PR3. Should a user of the identification transmitter IDG (on the right-hand side of the figure) now wish to find his/her vehicle, he/she will press a button (TAS) of his/her identification transmitter so that the latter will transmit an identification signal IDS. Since, however, the range of the identification transmitter IDG is limited, to an area with a radius RI in the example shown here, the identification signal IDS of the identification transmitter IDG will only be able to be received by vehicles within the radius RI. In the example shown here, it is assumed that the vehicle FZ1 receives the identification signal IDS and evaluates it by means of an identification arrangement, as already explained in relation to FIG. 1. In this case it transpires that the identification code transmitted with the identification signal IDS is invalid or that the vehicle FZ1 is not assigned to the identification transmitter IDG, with the result that the vehicle retransmits the identification signal, represented in this case by the identification signal IDS′. It is assumed here that the vehicle FZ1 is able to transmit at a higher transmit level than the identification transmitter IDG, so the range of the transmitting/receiving device of the vehicle FZ1 is indicated here in the figure by an area around the vehicle FZ1 with the radius R1. The transmitted identification signal IDS′ is finally received by a second vehicle FZ2 which in turn has an identification arrangement for the purpose of evaluating the received identification signal of the identification code contained therein, as has already been explained above in relation to the vehicle FZ2. In the example of FIG. 3, the vehicle FZ2 also establishes that the identification code contained in the identification signal of the identification transmitter IDG is not valid and so the vehicle FZ2 is not assigned to the identification transmitter IDG. Consequently, the vehicle FZ2 again transmits the identification signal, as indicated in the figure by the identification signal IDS″.

The identification signal IDS′ is now received by a vehicle within the transmission range R2 of the vehicle FZ2, namely by the vehicle FZ3 in the example. In the same way as the two vehicles FZ1 and FZ2 did previously, the vehicle FZ3 now also checks whether the identification code contained in the identification signal IDS″ is valid or whether the vehicle FZ3 is assigned to the identification transmitter IDG. In the example of FIG. 3, the vehicle FZ3 now establishes that the identification code is valid, and a control device provided in the vehicle FZ3 now activates a lighting device BL3 to output one or more optical signals or flashing signals. The user of the identification transmitter IDG can see this and now knows where his/her vehicle FZ3 is parked.

Reference will now be made to FIG. 4, in which an embodiment of the identification signal IDS is shown in a schematic representation. In this case the identification signal IDS can, as already mentioned above, include the identification code CO, as well as further information. For example, it can also include address information AD which, as in the example of FIG. 4, has two areas or sections B1 and B2. The address information can be information which is specific to a particular identification transmitter. Since a plurality of identification transmitters are normally assigned to a vehicle, the vehicle can therefore ascertain from which of the identification transmitters an identification signal originates. For example, in this regard it can be specified during a training phase that when an identification signal is received from a specific identification transmitter, a specific vehicle function will be activated, for example that only the lighting device will flash when a valid identification signal is received from a first identification transmitter, whereas when a valid identification signal is received from a second identification transmitter, both a flashing of the lighting device and a sounding of the horn will take place for the vehicle locating function (car finder function). Information or a configuration of this kind, controlling which functions are to be executed when a valid identification signal (in particular from a specific identification transmitter) is detected, can be stored for example in a memory (cf. SP1, SP2) of a control device (cf. ST1, ST2) of the vehicle.

It is furthermore conceivable that one of the areas B1 or B2 is blocked or cannot be read, which constitutes information for a vehicle receiving the identification signal that if the result of the check is negative, the identification signal IDS may not be forwarded. Blocking information of this kind can be set by the user of an identification transmitter for example in order to avoid further persons being informed about the location of his/her vehicle, in particular if the vehicle is parked at a relatively great distance from the identification transmitter or the user. In particular when the identification signal IDS is not only to serve for identifying or making known the location of a vehicle, but also to effect an unlocking of door locks because the identification system or the identification arrangement in a vehicle is part of the access arrangement, it can be advantageous in certain cases to provide blocking information as described above or any other blocking information (for forwarding) in the identification signal.

Furthermore, in addition or alternatively to the address information AD in the identification signal IDS it is possible to provide the hopping information Z, which includes for example a counter that can be updated or incremented each time the identification signal IDS is forwarded. In addition to the hopping information, a limit value or limit value information G can also be provided which specifies how often an identification signal may be forwarded. This limit value information G can be inserted by the identification transmitter IDG transmitting the identification signal IDS. The limit value information G (in particular in conjunction with the hopping information) can therefore be used as blocking information. In particular in the case where the limit value information G contains the value “0”, no forwarding whatsoever is permitted.

What is claimed is:

1. An identification arrangement for a vehicle, comprising:
a vehicle-side transmitting/receiving device for receiving an identification signal containing an identification code; and
a control and evaluation device operable:
to check the identification code of the identification signal,
to output a control signal for activating a vehicle function device if the identification code was recognized as valid, or
to prompt the vehicle-side transmitting/receiving device so that the latter will retransmit the identification signal if the identification code was recognized as invalid.

2. The identification arrangement according to claim 1, wherein the vehicle function device has output means for outputting signals which can be perceived by a user upon its activation.

3. The identification arrangement according to claim 1, wherein the identification signal includes blocking information which prevents the retransmission of the identification signal by the vehicle-side transmitting/receiving device.

4. The identification arrangement according to claim 1, wherein the identification signal includes count information which is incremented before a retransmission of the identification signal.

5. The identification arrangement according to claim 4, wherein the vehicle-side transmitting/receiving device does not retransmit the identification signal if the count information exceeds a predefined limit value.

6. The identification arrangement according to claim 1, further comprising a mobile identification transmitter assigned to a user and configured to transmit an identification signal containing an identification code.

7. The identification arrangement according to claim 6, wherein the mobile identification transmitter also provides address information that is characteristic of it in the identification signal.

8. The identification arrangement according to claim 3, wherein at least one section of the address information is blocked, and by this means the blocking information is implemented.

9. A vehicle having an identification arrangement comprising:
a vehicle-side transmitting/receiving device for receiving an identification signal containing an identification code; and
a control and evaluation device operable:
to check the identification code of the identification signal,
to output a control signal for activating a vehicle function device if the identification code was recognized as valid, or
to prompt the vehicle-side transmitting/receiving device so that the latter will retransmit the identification signal if the identification code was recognized as invalid.

10. The vehicle according to claim 9, wherein the vehicle function device has output means for outputting signals which can be perceived by a user upon its activation.

11. The vehicle according to claim 9, wherein the identification signal includes blocking information which prevents the retransmission of the identification signal by the vehicle-side transmitting/receiving device and/or the identification signal includes count information which is incremented before a retransmission of the identification signal.

12. The vehicle according to claim 12, wherein the vehicle-side transmitting/receiving device does not retransmit the identification signal if the count information exceeds a predefined limit value.

13. The vehicle according to claim 9, comprising a mobile identification transmitter assigned to a user and configured to transmit an identification signal containing an identification code and wherein the mobile identification transmitter also provides address information that is characteristic of it in the identification signal.

14. The vehicle according to claim 11, wherein at least one section of the address information is blocked, and by this means the blocking information is implemented.

15. A method for identifying an identification signal, comprising the steps of:
Reception of an identification signal containing an identification code by a vehicle;
Checking of the identification code of the identification signal;
Execution of a vehicle function if the identification code was recognized as valid, or
retransmission of the identification signal if the identification code was recognized as invalid.

16. The method according to claim 15, wherein the vehicle function includes a transmitting of signals that can be perceived by a user.

17. The method according to claim 15, wherein the identification signal includes blocking information which prevents the retransmission of the identification signal.

18. The method according to claim 15, wherein the identification signal includes count information which is incremented before a retransmission of the identification signal.

19. The method according to claim 18, wherein the identification signal is not retransmitted if the count information exceeds a predefined limit value.

20. The method according to claim 15, wherein the identification signal received by the vehicle is transmitted by a mobile identification transmitter.
